(19) United States
(12) Patent Application Publication
(10) Pub. No.: US 2005/0041829 A1
(43) Pub. Date: Feb. 24, 2005

(54) SPEAKER AND METHOD OF INSTALLING THE SAME

(75) Inventors: Yasuhisa ABE, Tendo-shi, Yamagata (JP); Takayuki NEGISHI, Tendo-shi, Yamagata (JP); Takeshi ITO, Tendo-shi, Yamagata (JP); Katsuhiro SASAKI, Tendo-shi, Yamagata (JP); Toshihiko HIKICHI, Tendo-shi, Yamagata (JP); Hiroyuki HAMADA, Tokorozawa-shi, Saitama (JP); Shintaro HOSOI, Tokorozawa-shi, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: PIONEER CORPORATION, Tokyo (JP); TOHOKU PIONEER CORPORATION, Tendo-shi, Yamagata (JP)

(21) Appl. No.: 10/710,916

(22) Filed: Aug. 12, 2004

(30) Foreign Application Priority Data
Aug. 19, 2003 (JP) 2003-207812

(51) Int. Cl. H04R 25/00; H04R 1/00; H04R 9/06; H04R 11/02

(52) U.S. Cl. 381/398; 381/396

(57) ABSTRACT

A magnet (300) is arranged substantially at the center of the bottom section (210) of a frame (200) and a diaphragm (500) provided with a coil bobbin (570) around which a voice coil (600) is wound is fitted to the frame (200) so as to close the opening (233) of the frame (200). Then, the diaphragm (500) is covered by a protective member (700). A fitting section (240) to be fitted to a receiving member (800) is extended from the outer peripheral surface of the bottom section (210) of the frame (200) substantially along a plane that includes the center of gravity G of the speaker and runs substantially in parallel with the plane of the opening of the frame (200), or a plane that includes the center of gravity G of the speaker and runs substantially perpendicularly to the direction of vibrations of the diaphragm (500) so as to appear like a sword guard. The transmission of vibrations of the diaphragm (500) to the receiving member (800) through the frame is suppressed without requiring the use of a separate member such as an anti-vibration member, and the sound quality of the speaker is prevented from being degraded by noises with a simple configuration.

### BACKGROUND OF THE INVENTION

1. Field of the Invention

The present invention relates to a speaker having a frame to be mounted on a receiving member and a method of installing the same.

2. Description of Related Art

When a conventional speaker of a vehicle emits sound, the vibrations of the diaphragm can be transmitted to the doors and the cabinet of the vehicle to give rise to noises, which degrades the quality of the emitted sound. Thus, techniques for preventing the vibrations of the speaker from being transmitted to a speaker receiving member are known (see, Prior Art Document 1: Japanese Patent Laid-Open Publication No. Hei 11-146471, p. 4, left column—p. 9, right column and Prior Art Document 2: Japanese Patent Laid-Open Publication No. Hei 11-146472, p. 3, right column—p. 6, left column).

Prior Art Document 1 describes the use of a support member having an end thereof arranged on a grounding surface so as to run through the cabinet covering the rear surface of the speaker and the other end supporting the speaker at the center of gravity of the speaker. In order for the speaker to be supported by the support member, the yoke or the frame of the speaker is made to have a large diameter and provided with a recessed or projected adjusting member corresponding to the center of gravity of the entire speaker such that the other end of the support member is linked to the adjusting member by inserting the other end of the support member into the adjusting member or by mutual screw engagement so as to place the center of gravity on the axial line of the support member. With this arrangement, vibrations of the speaker is suppressed by separating the cabinet from the speaker by means of the support member and absorbed by the grounding surface by way of the support member.

Prior Art Document 2 describes the use of a support member having an end thereof rigidly secured to the cabinet covering the rear surface of the speaker and the other end supporting the speaker at the center of gravity of the speaker, and an anti-vibration member arranged at the junction between the speaker and the cabinet. In order for the speaker to be supported by the support member, the yoke or the frame of the speaker is made to have a large diameter and provided with a recessed or projected adjusting member corresponding to the center of gravity of the entire speaker such that the other end of the support member is linked to the adjusting member by inserting the other end of the support member into the adjusting member or by mutual screw engagement so that the center of gravity is located on the axial line of the support member. With this arrangement, the speaker is directly supported by the support member to suppress unnecessary vibrations, and further, the vibrations are attenuated by the anti-vibration member so that the transmission of the vibrations to the cabinet is suppressed.

However, with the techniques described in the Prior Art Documents 1 and 2, it is not possible to downsize the speaker because the yoke or the frame is designed to have a large diameter so as to place the center of gravity on the yoke or the frame, and the support member for supporting the speaker is linked to the yoke or the frame. Further, there may arise a problem that the magnetic characteristics of the speaker can be altered by modifying the profile of the yoke

### SUMMARY OF THE INVENTION

A major object of the present invention is to provide a speaker that suppresses the transmission of vibrations to the receiving member with a simple arrangement and a method of installing such a speaker.

In an aspect of the present invention, the above object is achieved by providing a speaker adapted to be installed onto a receiving member and including: a frame showing substantially a profile of a frustum and having openings at the peripheral wall thereof, a magnetic circuit arranged on the frame, a diaphragm fitted to the frame, and a voice coil arranged on the diaphragm, the frame having a fitting section formed so as to include therein the center of gravity of the entire speaker and project along a plane substantially in parallel with the plane including the peripheral edges of the openings so as for the speaker to be installed onto the receiving member.

In another aspect of the present invention, provided is a speaker adapted to be installed onto a receiving member and including: a frame, a magnetic circuit arranged on the frame, a diaphragm fitted to the frame, and a voice coil arranged on the diaphragm, the frame having a fitting section formed so as to include therein the center of gravity of the entire speaker and project substantially along a plane intersecting the direction of vibration of the diaphragm so as for the speaker to be installed onto the receiving member.

In a further aspect of the present invention, provided is a speaker adapted to be installed onto a receiving member and including: a frame, a magnetic circuit arranged on the frame, a diaphragm fitted to the frame, and a voice coil arranged on the diaphragm, the frame having a fitting section formed so as to project substantially along a plane intersecting the direction of vibration of the diaphragm and adapted to be fitted to the receiving member so as to place the center of gravity of the entire speaker on a plane including the receiving member.

In still another aspect of the present invention, provided is a method of installing a speaker having a frame showing substantially a profile of a frustum and having openings at the peripheral wall thereof, a magnetic circuit arranged on the frame, a diaphragm fitted to the frame, and a voice coil arranged on the diaphragm onto a receiving member, the method including: installing the speaker in position so that the plane including the peripheral edges of the openings is substantially in parallel with a plane including the receiving member and the center of gravity of the entire speaker is located on the plane including the receiving member.

### BRIEF DESCRIPTION OF THE DRAWINGS

FIG. 1 is a schematic cross sectional view of an embodiment of speaker according to the present invention;

FIG. 2 is a schematic cross sectional view of a known speaker; and

FIG. 3 is a graph showing the frequency characteristics of the vibration acceleration to illustrate how vibrations are transmitted by the speaker.

### DETAILED DESCRIPTION OF PREFERRED EMBODIMENT(S)

Now, the present invention will be described in detail by referring to the accompanying drawings that schematically illustrate an embodiment of a speaker according to the present invention. While the embodiment of the speaker is adapted to be fitted to a vehicle, the present invention is by no means limited to such a speaker.

(Configuration of the Speaker)

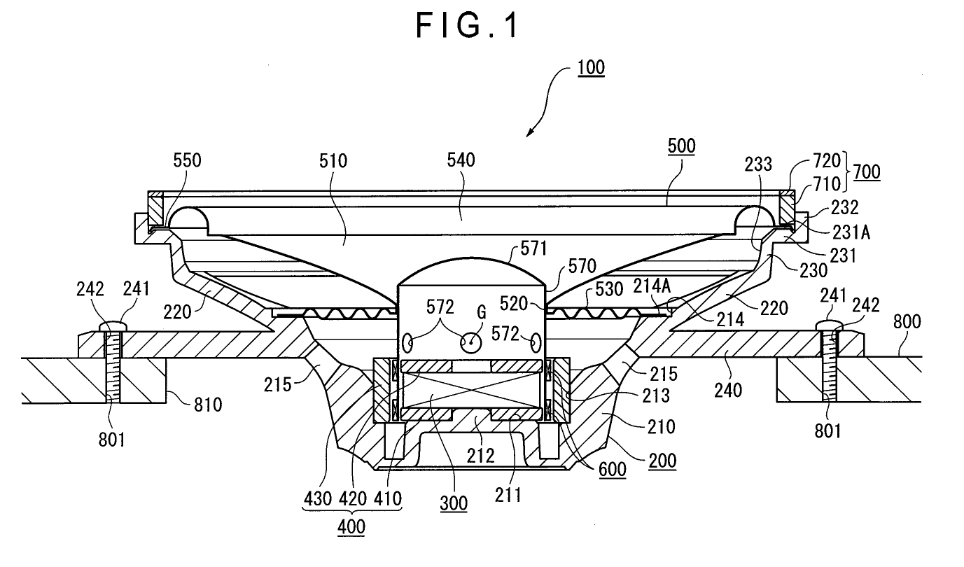

FIG. 1 is a schematic cross sectional view of an embodiment of speaker according to the present invention. Referring to FIG. 1, shown is a speaker 100 that is adapted to be typically fitted to one of the doors of a vehicle and output sounds in response to the sound data transmitted to it from a replay unit mounted in the vehicle. The speaker 100 has a frame 200, a magnet 300 that is a component of a magnetic circuit, a magnetic body 400 that is another component of the magnetic circuit, a diaphragm 500, a voice coil 600 and a protective member 700.

The frame 200 is typically made of a hard synthetic resin material or a lightweight metal material such as an aluminum alloy. The frame 200 has a recessed bottom section 210 that is gradually expanded to a side. A substantially cylindrical positioning projection 212 is projecting substantially from the center of the bottom surface 211 of the bottom section 210. A stepped positioning section 213 is formed along the peripheral edge of the bottom surface 211 of the bottom section 210. The inner peripheral surface of the stepped positioning section 213 is substantially cylindrical. The bottom section 210 is provided along the expanded peripheral edge thereof with a first stepped fitting section 214 having a first fitting surface 214A that is substantially in parallel with the bottom surface. Further, the bottom section 210 is provided with a plurality of openings 215 located between the stepped positioning section 213 and the first stepped fitting section 214 so as to allow the inner peripheral surface and the outer peripheral surface of the bottom section 210 to communicate with each other.

The frame 200 is integrally provided with a plurality of rod-shaped link sections 220 that project from the peripheral edge of the bottom section 210 in radial directions. The link sections 220 have a profile that is wide both at the base end close to the bottom section 210 and at the front end but narrow at the middle part. The frame 200 is also provided with a ring-shaped annular section 230 linking the front ends of the link sections 220. The annular section 230 of the frame 200 is provided with a second stepped fitting section 231 that is extending outwardly from the front edge of the annular section 230 to form a second fitting surface 231A that is substantially in parallel with the bottom surface 211 and shows a large outer diameter. Thus, the second stepped fitting section 231 has the shape of a sword guard. A substantially cylindrical positioning rib 232 is arranged along the outer peripheral edge of the second stepped fitting section 231 so as to project forwardly from the open side of the bottom section 210. Thus, the inner peripheral edge of the annular section 230 defines the inner peripheral edge of the opening 233 of the frame 200 at the front side thereof so that the frame 200 has a profile of a frustum that is open at the front side as a whole.

The frame 200 is further provided on the outer peripheral surface of the bottom section 210 with a fitting section 240 extending substantially from the peripheral edge of the bottom section 210 in parallel with the plane including the peripheral edge of the opening 233, or the opening plane, as integral part thereof so as to appear like a sword guard. The fitting section 240 has a substantially circular outer peripheral edge. The fitting section 240 is provided at predetermined positions near the outer peripheral edge thereof with a plurality of, e.g., three, through-holes 242 for receiving respective fitting members 241 such as screws. If viewed from above, the through-holes 242 are arranged outside the circle defined by the outer front ends of the positioning ribs 232. In other words, the fitting section 240 has an outer diameter greater than the outer diameter of the circle defined by the outer front ends of the positioning ribs 232.

The magnet 300 typically has a cylindrical profile so that its axially opposite surfaces operate as magnetic polar surfaces. The magnet 300 is arranged substantially at the center of the bottom section 210 of the frame 200 and mounted on the positioning projection 212 with its axis aligned with the axis of the frame 200 and bonded to the projection 212 typically by means of an adhesive agent.

The magnetic body 400 has a lower yoke 410, an upper yoke 420 and an outer circumferential yoke 430. The lower yoke 410 is made of a magnetic material and has a substantially ring-shaped profile with predetermined dimensions in terms of peripheries and thickness. The lower yoke 410 is arranged under one of the opposite ends of the magnet 300 at a position where the positioning projection 212 of the bottom section 210 of the frame 200 is inserted into it along the inner periphery thereof so that it is put on the bottom surface 211 and pinched between the bottom section 210 and the magnet 300. Then, it is secured to the bottom surface 211 typically by means of an adhesive agent so as to be laid under the corresponding surface of the magnet 300. The upper yoke 420 is made of a material same as that of the lower yoke 410 and also has a ring-shaped profile same as that of the lower yoke 410. The upper yoke 420 is secured to the opposite surface of the magnet 300 typically by means of an adhesive agent so as to sandwich the magnet between itself and the lower yoke 410.

The outer circumferential yoke 430 is made of a material same as that of the lower yoke 410 and the upper yoke 420 and has a substantially hollow cylindrical profile. The outer circumferential yoke 430 has an inner diameter larger than the outer diameter of the lower and upper yokes 410 and 420 and substantially same as the inner diameter of the stepped positioning section 213 of the bottom section 210 of the frame 200 and has an axial length greater than the distance between the opposite outer surfaces of the lower yoke 410 and the upper yoke 420 that sandwich the magnet 300. The outer circumferential yoke 430 is held in engagement with the stepped positioning section 213 of the bottom section 210 of the frame 200 and secured typically by means of an adhesive agent. As the outer circumferential yoke 430 is secured in position, a magnetic gap of a predetermined dimension is produced between the inner peripheral surface of the outer circumferential yoke 430 and the outer peripheral surfaces of the lower and upper yokes 410 and 420. Thus, a passage for the magnetic flux of the magnet 300 to pass through the magnetic gap is defined by the lower yoke 410, the upper yoke 420 and the outer circumferential yoke 430. In other words, a magnetic circuit is formed by the magnet 300 and the magnetic body 400.

The diaphragm 500 is substantially a thin film made of a magnesium thin plate, cone paper or a sheet of any of various fibers that is surface-treated for anti-corrosion. The diaphragm 500 has a vibratory section 510 substantially having a profile of an upwardly expanded frustum of cone. A substantially cylindrical fitting cylinder 520 is fitted to the inner peripheral edge of the vibratory section 510. A fitting supporting section (damper) 530 is fitted to the fitting cylinder 520 so as to project outwardly in radial directions like a sword guard and has a bellows-like cross section so as to be able to contract. The fitting supporting section 530 has an outer diameter substantially same as the inner diameter of the first stepped fitting section 214 of the frame 200 and secured to the first fitting surface 214A of the first stepped fitting section 214 typically by means of an adhesive agent. An edge section 540 is integrally extended from the outer peripheral edge of vibratory section 510 so as to show a substantially U-shaped cross section with the bottom of U projecting upward, or in the expanding direction of the vibratory section 510. Further, a fitting flange 550 is integrally and outwardly extended from the outer peripheral edge of the edge section 540 like a sword guard and secured to the second fitting surface 231A of the second stepped fitting section 231 of the frame 200 typically by means of an adhesive agent. Alternatively, the edge section 540 may be provided as a separate member that is fitted to a part of the vibratory section 510 located near the outer peripheral edge thereof so as to make an integral part of the diaphragm 500.

The diaphragm 500 is also provided as an integral part thereof with a coil bobbin 570. The coil bobbin 570 is typically made of metal such as aluminum or synthetic resin that may or may not contain fiber such as glass fiber and has a substantially cylindrical profile with an inner diameter greater than the outer diameter of the lower and upper yokes 410 and 420 of the magnetic body 400 and an outer diameter smaller than the inner diameter of the outer circumferential yoke 430 of the magnetic body 400. A dust cap 571 made of a material, for example, same as that of the diaphragm 500 and the coil bobbin 570 and having a vault-like profile is secured to the upper axial edge of the coil bobbin 570 typically by means of an adhesive agent so as to make an integral part of the coil bobbin 570. Further, the coil bobbin 570 is provided with a plurality of ventilation through-holes 572, for example, arranged peripherally at regular intervals at an axially middle level so as to allow the inner peripheral surface and the outer peripheral surface of the coil bobbin 570 to communicate with each other. Then, the coil bobbin 570 is inserted into the fitting cylinder 520 of the diaphragm 500 from the lower end thereof and secured to the fitting cylinder 520 so as to be mounted in the diaphragm 500 and become an integral part thereof.

The diaphragm 500 is then secured to the first fitting surface 214A of the first stepped fitting section 214 of the frame 200 at the outer peripheral edge of the fitting supporting section 530 typically by means of an adhesive agent and also to the second fitting surface 231A of the second stepped fitting section 231 of the frame 200 at the fitting flange 550 also typically by means of an adhesive agent so as to close the opening 233 of the frame 200. As the diaphragm 500 is mounted in the frame 200, the lower end of the coil bobbin 570 is placed in the magnetic gap without contacting the magnetic body 400.

The voice coil 600 is wound around the outer peripheral surface of the coil bobbin 570 near the lower end thereof. The wound voice coil 600 is secured to the coil bobbin 570 typically by means of an adhesive agent. More specifically, the voice coil 600 is wound at positions corresponding to those of the lower yoke 410 and the upper yoke 420 in a state where the diaphragm 500 is mounted in the frame 200. The opposite ends of the wire of the voice coil 600 are drawn to the side opposite to the expanded open side of the frame 200 so as to operate as input terminals of audio signals.

The protective member 700 has a cylinder (gasket) 710 and a mesh member 720. The cylinder 710 is typically made of synthetic resin and has an outer diameter substantially same as the inner diameter of the positioning rib 232 of the frame 200. The mesh member 720 is typically made of punched metal and arranged so as to cover the upper axial end of the cylinder 710 and become an integral part thereof. The cylinder 710 and the mesh member 720 of the protective member 700 may be formed integrally with each other by means of any of various known techniques. For example, the cylinder 710 may be made integral with the mesh member 720 by insert or outsert molding or by bonding, using an adhesive agent. The protective member 700 is secured to the frame 200 typically by means of an adhesive agent as the cylinder 710 is inserted into the positioning rib 232 of the frame 200.

As the magnet 300, the magnetic body 400, the diaphragm 500 in which the voice coil 600 is arranged and the protective member 700 are mounted in the frame 200, if the center of gravity G of the speaker 100 is located at the position indicated in FIG. 1, for instance, the fitting section 240 projects horizontally outwardly on the plane that includes the center of gravity and runs substantially in parallel with the plane of the opening 233. In other words, the fitting section 240 projects horizontally outwardly on the plane that includes the center of gravity G and runs substantially perpendicularly relative to the direction of vibration of the diaphragm 500. Further, the center of gravity G of the speaker 100 is located within the triangle formed by connecting the three through-holes 242 arranged near the outer peripheral edge of the fitting section 240 and separated from the centers of the through-holes 242 by the same distance.

The speaker 100 is mounted on a receiving member 800, which may be a structure of a vehicle, or one of the doors of the vehicle, as fitting members 241, which are typically screws, are driven respectively into the through-holes 242 of the fitting section 240 and then into female-threaded holes 801 of the receiving member 800, so that the speaker 100 is fitted to the receiving member 800 with a part of the bottom section 210 is inserted into a receiving opening 810 that is open at the receiving member 800. When the speaker 100 is mounted in position, the center of gravity G of the speaker 100 is substantially located on the plane that substantially perpendicularly intersects the direction of vibration of the diaphragm 500 and includes the receiving member 800. When the receiving member 800 is arranged on one of the doors of a vehicle, the fitting section 240 is fitted to the inner panel of the door and the positioning rib 232 of the frame 200 is arranged along the edge of the opening of the door trim arranged on the inner surface side of the inner panel so that the speaker 100 may not project from the door.

(Operation of the Speaker)

Now, how vibrations are transmitted from the above-described speaker 100 as the speaker 100 is operated will be described by referring to the figure that illustrates some of the results obtained as a result of an experiment.

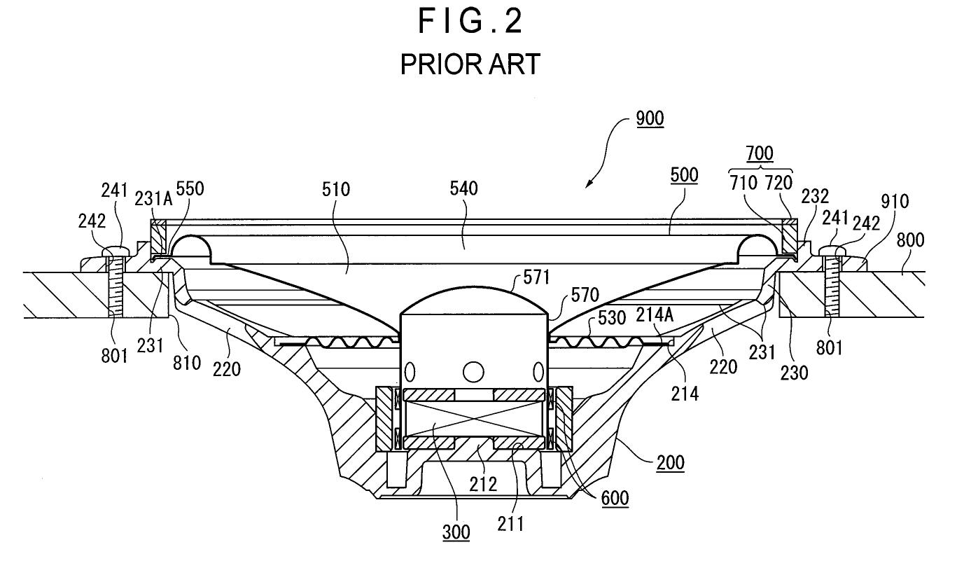

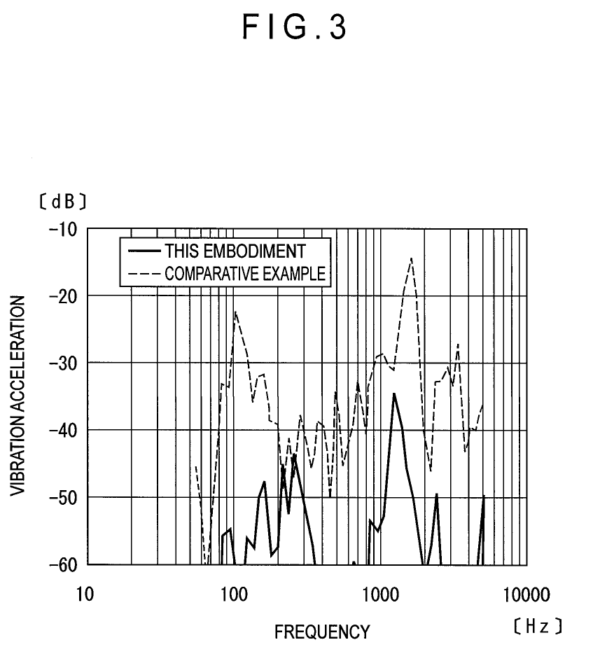

FIG. 2 is a schematic cross sectional view of a known speaker 900 and FIG. 3 is a graph obtained by observing vibrations.

The speaker 100 is mounted on the receiving member 800, which is the inner panel of one of the doors of a vehicle and the transmission of vibrations of the speaker 100 to the inner panel is observed. For the purpose of comparison, a known speaker 900 as shown in FIG. 2 is also mounted on the inner panel of the door of the vehicle and the transmission of vibrations of the speaker 900 to the inner panel is also observed. Referring to FIG. 2, the components of the known speaker 900 that are the same as those of the speaker 100 of FIG. 1 are denoted respectively by the same reference symbols and will not be described any further. The speaker 900 for comparison shown in FIG. 2 has a fitting section 910 having through-holes 242, through which fitting members 241 are respectively driven. The fitting section 910 extends from the second stepped fitting section 231 so as to start from the outer peripheral surface of the positioning rib 232 of the frame 200 like a sword guard and operates like the fitting section 240 of the speaker 100. The speaker 900 is mounted on the inner panel at the fitting section 910 and the transmission of vibrations of the speaker 900 is observed in the experiment. FIG. 3 shows some of the results of the experiment with the condition below.

Instrument: Acceleration Pickup

point of observation: the magnetic circuit (in a direction perpendicular to the direction of vibration of the diaphragm)

As seen from the graph of FIG. 3, when compared with the known speaker 900, the transmission of vibrations of the speaker 100 to the inner panel of the door is suppressed over a wide frequency band without requiring the use of any separate anti-vibration member because the fitting section 240 is properly provided to be fitted to the receiving member 800

(Advantages of the Speaker 100)

As described above, the frame 200 of this embodiment that is provided with a magnet 300, a magnetic body 400, a diaphragm 500, on which a voice coil 600 is arranged, and a protective member 700 is also provided with a fitting section 240 that projects horizontally outwardly on the plane that includes the center of gravity G of the entire speaker 100 and runs substantially in parallel with the plane of the opening. In other words, the fitting section 240 projects horizontally outwardly on the plane that includes the center of gravity G and runs substantially perpendicularly relative to the direction of vibration of the diaphragm 500. Thus, the speaker 100 is fitted to the receiving member 800 by the fitting section 240. With this arrangement, the center of gravity G of the speaker 100 is located on the plane that runs perpendicularly relative to the direction of vibration of the diaphragm 500 and includes the receiving member 800 so that the transmission of vibrations of the diaphragm 500 caused by a sound signal input to the speaker 100 to the receiving member 800 by way of the frame 200 is suppressed without requiring the use of any separate anti-vibration member. Thus, the sound quality of the speaker 100 will not be degraded by noises.

Further, the fitting section 240 of the frame 200 that projects outwardly like a sword guard is provided near the outer peripheral edge thereof with a plurality of through-holes 242 for receiving respective fitting members 241 in such a way that the center of gravity G is located within the triangle formed by connecting the through-holes 242. Thus, the speaker 100 is not held like a cantilever and fitted stably so that the transmission of vibrations of the diaphragm 500 can be efficiently suppressed.

Further, the through-holes 242 of the fitting section 240 are separated from the center of gravity G by the same distance. Therefore, the speaker 100 can be mounted in a stable fashion and the transmission of vibrations can be efficiently suppressed.

Still further, since the fitting section 240 is designed to project beyond the outer peripheral surface of the bottom section 210, the receiving opening 810 of the receiving member 800 for receiving the speaker 100 can be made to have a reduced area if compared with its counterpart for receiving the known speaker 900 so that the rigidity of the receiving member 800 will not be reduced and consequently the generation of noises due to the transmission of vibrations to the receiving member 800 is reduced. Thus, the quality of sound of the speaker will not be degraded by noises.

Still further, the fitting section 240 that projects outwardly is formed integrally with the frame 200 to eliminate an operation of fitting a separate fitting section 240 to the frame 200 and improve the assembling efficiency.

Still further, the fitting section 240 is formed to have the largest outer diameter and is provided with a plurality of through-holes 242 and, if viewed from above, the through-holes 242 are arranged outside the circle defined by the outer periphery of the positioning ribs 232. With this arrangement, the speaker 100 having the fitting section 240 that projects on a plane that includes the center of gravity G of the speaker 100 can be mounted on the receiving member 800 from the front side just like the known speaker 900.

Furthermore, if the vehicle in which the speaker is installed is lightweight and hence shows a relatively low level of rigidity, the speaker 100 can effectively prevent the transmission of vibrations. Conversely, vibrations of the receiving member 800 that can be generated when the vehicle is running are hardly transmitted to the speaker 100 so that the speaker 100 can provide high quantity sounds.

(Modifications to the Embodiment)

The present invention is by no means limited to the above-described embodiment, which may be modified and altered in various different ways without departing from the scope of the present invention.

While the embodiment is installed in a vehicle in the above description, it may alternatively be mounted in a speaker cabinet or installed in a building or some other structures. In other words, the object of installation of the embodiment is not particularly subjected to limitations.

The frame 200 does not necessarily have to have a profile of a frustum formed by linking an annular section 230 to the bottom section 210 at the link section. For example, if the frame 200 is made to have small dimensions so as to be used in a portable device such as a mobile phone or a notebook type personal computer, it may alternatively be made to have a profile of a hollow cylinder. In other words, the profile of the frame is not particularly subjected to limitations.

While the magnetic body 400 is designed such that the magnet 300 is sandwiched between the lower yoke 410 and the upper yoke 420 thereof and a passage for the magnetic flux of the magnet 300 to pass through the magnetic gap is defined by the lower yoke 410, the upper yoke 420 and the outer circumferential yoke 430 in the above description, an inner magnet type magnetic circuit, an outer magnet type magnetic circuit or a magnetic circuit of some other type may alternatively be used for the purpose of the present invention.

The configuration of the diaphragm 500 is not limited to the above-described one. For example, a voice coil 600 formed on the vibratory section 510 as an extended and bent part thereof that shows a substantially hollow cylinder profile may be directly wound around the diaphragm 500 without using a coil bobbin 570. In other words, the configuration of the diaphragm 500 is not particularly subjected to limitations.

While a protective member 700 is provided in the above-described embodiment, it is not necessary to use the protective member 700 so long as the fitting section 240 satisfies the above-described requirements relating to the center of gravity G without using the protective member 700. Note, however, that the protective member 700 is relatively lightweight and hence the thickness of the fitting section 240 can accommodate it, therefore, it may not be necessary to design a frame 200 that does not use a protective member 700.

Further, in the above-description, the fitting section 240 is formed to have the largest outer diameter and mounted from the front side. However, for example, the fitting section 200 may have an outer diameter smaller than the positioning rib 232 of the frame 200 and may be mounted from the rear side.

Any specific structural elements and any parts of the procedure for embodying the present invention can be appropriately modified without departing from the scope of the present invention.

[Advantages of the Embodiment]

As described above, the frame 200 of the above-described embodiment is provided with a fitting section 240 projecting horizontally outwardly on the plane that includes the center of gravity G of the entire speaker 100 and running substantially in parallel with the plane of the opening of the frame 200 and then the frame 200 is fitted to the receiving member 800 at the fitting section 240. Therefore, the transmission of vibrations of the diaphragm 500 to the receiving member 800 through the frame 200 is suppressed and the sound quality of the speaker can be prevented from being degraded by noises.

Further, the fitting section 240 of the frame 200 projects substantially along the plane that includes the center of gravity G and runs substantially perpendicularly relative to the direction of vibration of the diaphragm 500 and then it is fitted to the receiving member 800. Therefore, the transmission of vibrations of the diaphragm 500 to the receiving member 800 through the frame 200 is suppressed and the sound quality of the speaker can be prevented from being degraded by noises.

Finally, since the fitting section 240 of the frame 200 is fitted to the speaker receiving member 800 in a state where the center of gravity G is located substantially on a plane that runs along a plane substantially perpendicular relative to the direction of vibrations of the diaphragm 500 and includes the speaker receiving member 800, the transmission of vibrations of the diaphragm 500 to the speaker receiving member 800 through the frame 200 is suppressed and the sound quantity of the speaker can be prevented from being degraded by noises.

1. A speaker adapted to be installed onto a receiving member, comprising:
a frame showing substantially a profile of a frustum and having openings at the peripheral wall thereof;
a magnetic circuit arranged on the frame;
a diaphragm fitted to the frame; and
a voice coil arranged on the diaphragm;
the frame having a fitting section formed so as to include therein the center of gravity of the entire speaker and project along a plane substantially in parallel with the plane including the peripheral edges of the openings so as for the speaker to be installed onto the receiving member.

2. A speaker adapted to be installed onto a receiving member, comprising:
a frame;
a magnetic circuit arranged on the frame;
a diaphragm fitted to the frame; and
a voice coil arranged on the diaphragm;
the frame having a fitting section formed so as to include therein the center of gravity of the entire speaker and project substantially along a plane intersecting the direction of vibration of the diaphragm so as for the speaker to be installed onto the receiving member.

3. A speaker adapted to be installed onto a receiving member and comprising:
a frame;
a magnetic circuit arranged on the frame;
a diaphragm fitted to the frame; and
a voice coil arranged on the diaphragm;
the frame having a fitting section formed so as to project substantially along a plane intersecting the direction of vibration of the diaphragm and adapted to be fitted to the receiving member so as to place the center of gravity of the entire speaker on a plane including the receiving member.

4. The speaker according to claim 2, wherein the fitting section projects substantially along a plane perpendicular to the direction of vibrations of the diaphragm.

5. The speaker according to claim 3, wherein the fitting section projects substantially along a plane perpendicular to the direction of vibrations of the diaphragm.

6. The speaker according to claim 1, wherein
the frame is provided with a bottom section for receiving the magnetic circuit, the bottom section having an opening defined by the peripheral edge thereof that is expanded toward a side of the bottom section to make the bottom section show a profile of a frustum and adapted to be closed when the diaphragm is fitted to the tip of the peripheral edge, and
the fitting section projects outwardly from the outer peripheral surface of the bottom section.

7. The speaker according to claim 2, wherein
the frame is provided with a bottom section for receiving the magnetic circuit, the bottom section having an opening defined by the peripheral edge thereof that is expanded toward a side of the bottom section to make the bottom section show a profile of a frustum and adapted to be closed when the diaphragm is fitted to the tip of the peripheral edge, and
the fitting section projects outwardly from the outer peripheral surface of the bottom section.

8. The speaker according to claim 3, wherein
the frame is provided with a bottom section for receiving the magnetic circuit, the bottom section having an opening defined by the peripheral edge thereof that is expanded toward a side of the bottom section to make the bottom section show a profile of a frustum and adapted to be closed when the diaphragm is fitted to the tip of the peripheral edge, and
the fitting section projects outwardly from the outer peripheral surface of the bottom section.

9. The speaker according to claim 1, wherein the fitting section is integrally formed with the frame so as to project from the frame.

10. The speaker according to claim 2, wherein the fitting section is integrally formed with the frame so as to project from the frame.

11. The speaker according to claim 3, wherein the fitting section is integrally formed with the frame so as to project from the frame.

12. The speaker according to claim 1, wherein the fitting section has a plurality of fitting positions for it to be fitted to the receiving member that are separated from the center of gravity by the same distance.

13. The speaker according to claim 2, wherein the fitting section has a plurality of fitting positions for it to be fitted to the receiving member that are separated from the center of gravity by the same distance.

14. The speaker according to claim 3, wherein the fitting section has a plurality of fitting positions for it to be fitted to the receiving member that are separated from the center of gravity by the same distance.

15. The speaker according to claim 1, wherein the fitting section has a plurality of fitting positions for it to be fitted to the receiving member and the center of gravity of the speaker is located within the region defined by linking the adjacent one of the fitting positions.

16. The speaker according to claim 2, wherein the fitting section has a plurality of fitting positions for it to be fitted to the receiving member and the center of gravity of the speaker is located within the region defined by linking the adjacent one of the fitting positions.

17. The speaker according to claim 3, wherein the fitting section has a plurality of fitting positions for it to be fitted to the receiving member and the center of gravity of the speaker is located within the region defined by linking the adjacent one of the fitting positions.

18. The speaker according to claim 1, wherein the receiving member is a structure of a vehicle.

19. The speaker according to claim 2, wherein the receiving member is a structure of a vehicle.

20. The speaker according to claim 3, wherein the receiving member is a structure of a vehicle.

21. A method of installing a speaker having a frame showing substantially a profile of a frustum and having openings at the peripheral wall thereof, a magnetic circuit arranged on the frame, a diaphragm fitted to the frame and a voice coil arranged on the diaphragm onto a receiving member; the method comprising:
installing the speaker in position so that the plane including the peripheral edges of the openings is substantially in parallel with the plane including the receiving member and the center of gravity of the entire speaker is located on the plane including the receiving member.
